(19) United States
(12) Patent Application Publication
(10) Pub. No.: US 2015/0226254 A1
(43) Pub. Date: Aug. 13, 2015

(54) COUPLER FOR ANIMAL

(71) Applicant: TARKY CO., LTD., Osaka (JP)

(72) Inventors: Seiji Nonoguchi, Osaka (JP); Tsuyoshi Nakata, Osaka (JP)

(73) Assignee: TARKY CO., LTD., Osaka (JP)

(21) Appl. No.: 14/430,421

(22) PCT Filed: Oct. 3, 2012
(86) PCT No.: PCT/JP2012/006369

§ 371 Date: Mar. 23, 2015

(51) Int. Cl. F16B 45/04; A01K 27/00

(52) U.S. Cl. CPC F16B 45/04; A01K 27/003

(57) ABSTRACT

A coupler includes: a hook portion; a stem portion extending from an end portion of the hook portion in a first direction; a slide bar closing and opening the hook portion by reciprocating in the first direction; a connection ring rotatably connected to an end of the stem portion with respect to the first direction, having a predetermined contour, and extending in a second direction perpendicular to the first direction; at least one projection extending from an outer circumferential portion of the connection ring in the second direction by a predetermined length; and an operation member connected to the slide bar and extending toward the connection ring. The operation member abuts only the projection when being moved in the first direction.

### FIELD

The present invention relates to a coupler for animal, and more particularly relates to a coupler for joining an animal leash to a connection ring provided on a collar or a cloth which an animal wears for controlling or mooring the animal.

### BACKGROUND

With reference to FIG. 11, FIG. 12, FIG. 13, and FIG. 14, a conventional coupler for animal will be described below. In FIG. 11, shown is a state in which a leash 190 is joined to a collar 110 via a conventional coupler 100. As shown in FIG. 12, the coupler 100 includes a snap hook portion 104 constructed to be detachably connectable to a ring 108 fixed at the collar 110, and a connection ring 103 formed in a D character like shape to be engaged with the leash 190. The snap hook portion 104 is integrally formed with a hook portion 111 formed in a C character like shape and a stem portion 112. In the stem portion 112, a major diameter portion 116, a minor diameter portion 117, and a major diameter portion 115 are successively formed in an order from one end of the stem opposed to the hook portion 111 toward the hook portion 111. The connection ring 103 is provided with a through hole 114a formed in one line (straight portion) of D character shape. The connection ring 103 is rotatably engaged to the stem portion 112 (hook portion 111) in a manner such that the major diameter portion 116 and the major diameter portion 115 pinch one line (straight portion) of the connection ring 103.

Along a stem direction Ds, formed in the stem portion 112 is a bottomed hole 122 having an opening 121 disposed in an end surface 112a near the hook portion 111. In the stem portion 112, along the stem direction Ds, formed is a guide groove 123. Inside the hole 122, inserted in an order are a coil spring 124 and a slide bar 125 slidable along the stem direction Ds such that the coil spring 124 is compressed by the slide bar 125. The expansion force of the compressed coil spring 124 biases the slide bar 125 so that an apical surface of the slide bar 125 abuts on an apical surface 111a of the hook portion 111. The slide bar 125 is provided with a convexly shaped grip portion 126 integrally formed therewith, and is installed such that the grip portion 126 juts out from the hole 122 through the guide groove 123.

In the coupler 100, the apical surface of the slide bar 125 is separated from the apical surface 111a of the hook portion 111 by sliding the grip portion 126 temporarily toward the connection ring 103, causing a gap therebetween. The grip portion 126 is an operation member used for making the slide bar 125 slide. In this sense, the grip portion 126 is referred to as an “operation member 126”.

In a state where the gap is formed, the ring 108 and the hook portion 111 (the snap hook portion 104) can be joined by catching the hook portion 111 on the ring 108 of the collar 110 (FIG. 11). Thereafter, the apical surface of the slide bar 125 is allowed to abut on the apical surface 111a of the hook portion 111 again to close the hook portion 111 by the slide bar 125.

The conventional coupler, as mentioned in the above, is constructed such that the slide bar works to close the hook portion (snap hook) when joined to the other object. As long as the slide bar works normally, the joining condition is kept safety. However, the joining may be lost accidentally depending on the usage condition.

For example, the snap hook portion 104 may be accidentally detached from the ring 108 when an animal (dog a) is frightened or attracted by something while the animal is being led or held. Such an unexpected detachment results from an abnormal actions of the animal. Specifically, the abnormal actions of the animal may induce a state where the ring 108 of the collar 110 will press and move the operation member 126 of the hook portion 111. When the animal moves irregularly, the slide bar 125 (the operation member 126) may be moved back from the close position to the open position. Then, an opening portion of the snap hook portion 104 will be opened against a user's intention, releasing the ring 108 therefrom.

In FIG. 13, shown is one example of the couplers for animal which aim to prevent the slide bar from moving back against the user's intention, proposed by Patent Literature 1. A coupler 200 has a construction basically similar to that of the coupler 100 shown in FIG. 12, except that a stopper mechanism is added for preventing the slide bar 125 from moving back. Hereinafter, mainly described is the stopper mechanism particular to the coupler 200. The same reference symbols are assigned to the parts having basically the same functions as those of parts of the coupler 100 and the descriptions of those are omitted.

The stopper mechanism is composed of a stopper 6 and a wire rope 23. The stopper 6 is made of an elastic material to have a detachable/attachable opening 6a formed in a major arc cross section segment and to be attachable to and detachable from the stem portion 112 through the side thereof. The stopper 6 accepts the stem portion 112 through the opening 6a by being elastically widened and then is attached to the stem portion 112. In this attached state, the stopper 6 extends between the operation member 126 and a catch portion 3a and prevents the slide bar 125 from moving back via the operation member 126. The stopper 6 is connected to a portion of the coupler 200 and is prevented from being lost carelessly.

As described in the above, according to Patent Literature 1, aimed is to prevent an unexpected uncoupling by adding the stopper 6 and the wire rope 23 to the coupler. In Patent Literature 2, various forms by adding only a stopper to a coupler are proposed. A stopper mechanism, according to Patent Literature 2, is basically constructed such that the stopper physically prevents the operation member from moving back, and is structured in a basically same manner as in the stopper 6 except the shape of the stopper. Therefore, the descriptions of those are omitted.

In FIG. 14, shown is a coupler having a stopper mechanism proposed by Patent Literature 3, which physically prevents an operation member from moving back in a same manner as in Patent Literature 1 and Patent Literature 2. A stopper mechanism in a coupler 300 is not constructed by adding a member such as the stopper 6 or the wire rope 23 separate from the conventional coupler, as proposed by Patent Literature 1 and Patent Literature 2. The stopper mechanism in the coupler 300 is composed of an operation member 7 and a connection ring 1 basically same as the operation member 126 and the connection ring 103 that have been employed, respectively, but whose forms and constructions are changed. Hereinafter, mainly described is the stopper mechanism particular to the coupler 300. The same reference symbols are assigned to the parts having basically the same functions as those of parts of the coupler 100 and the descriptions of those are omitted.

As shown in FIG. 14(a), the operation member 7 is longer than the operation member 126, and is structured such that a retreat end portion 7d abuts or is located in proximity to an upper portion of the connection ring 1 when the slide bar 125 is at the closing position. More specifically, the operation member 7 is made by adding a member extending backward to the operation member 126, and can be integrally made. As shown in FIG. 14 (c) and FIG. 14 (d), the upper portion of the connection ring 1 is formed into generally an oval shaped ring (hereinafter referred to as a “discoid oval ring 1a”) with a discoid wall 1a which can be opposed to the retreat end portion 7d of the operation member 7 in an axis direction.

The discoid oval ring 1a is provided with two notched portions 31 formed at two positions on a diametral line perpendicular to a flat direction thereof such that the operation member 7 can move back therethrough without abutting the retreat end portion 7d. Resultantly, as shown in FIG. 14 (b), the operation member 7 can move back only when the retreat end potion 7d is positioned above any one of the notched portions 31. In other words, when the retreat end portion 7d is located on positions other than those above the notched portion 31, the upper portion of the discoid oval ring 1a prevents the operation member 7 from moving back.

### CITATION LIST

### Patent Literature

Patent Literature 1: Japanese Patent Application Laid-Open No. 2010-81902
Patent Literature 2: Japanese Patent Application Laid-Open No. 2011-229459
Patent Literature 3: Japanese Patent Application Laid-Open No. 2011-223933

### SUMMARY

### Technical Problem

The stopper mechanisms, in the couplers proposed by Patent Literature 1, Patent Literature 2, and Patent Literature 3, are constructed so that the operation member at the closing position is prevented from moving back by making the operation member abut on a physical means. Particularly, according to Patent Literature 1 and Patent Literature 2, required is a user's operation of attaching/detaching a stopper to/from a body of coupler. The stopper is separately provided from the coupler's body. In order to prevent the stopper from accidentally detaching from the body, additionally needed is a mooring member (a wire rope, for example) for securing the stopper to the body. The user is further required to operate the mooring member.

The stopper shall satisfy conflicting requests of both easy installation by the user with a little power and greater resistance force against an accidental external force as well as a complicated uninstall operation. That is, the stopper preferably has a more simple structure for the convenience of installation, but inevitably has a complicated structure imposing an awareness on the user to handle for uninstallation. Thus, according to the couplers proposed by Patent Literature 1 and Patent Literature 2, component parts composing the stopper mechanism are required separately from the body, causing the increase of manufacturing cost and handling operations by user. Furthermore, a problem may be caused by a complicated structure and age deterioration of elastic materials.

According to the coupler proposed by Patent Literature 3, the stopper mechanism is realized in a simpler structure by basically changing the shape of a portion of the body or forming integrally with the body. However, the discoid oval ring 1a of the connection ring 1 shall be made thicker only at the portion functioning as the stopper as being in contact with the retreat end portion 7d of the operation member 7, compared with the connection ring 103 in usual use.

Specifically, in a manufacturing process of the coupler 300, the connection ring 1 is formed by plastic deforming a circular ring formed by a thick circular wall 1a with the stem portion 112 (minor diameter portion 117) being inserted therein into a generally oval shape. However, since the notched portions 31 are formed in two opposed positions on the outer circumferential portion of the ring, stress easily concentrates or maldistributes, causing difficulties in forming a circular ring into a desirable oval shape as well as in a yield or a man-hour.

In light of the above mentioned problems, it is an object of the present invention to provide a coupler for animal having a stopper mechanism which is integrally formed with a body and which can prevent a movement of object to be coupled from transmitting to and applying a push-back force to a slide bar.

### Solution to Problem

In order to achieve the above object, a coupler for animal according to the present invention comprises:

a hook portion;

a stem portion extending from an end portion of the hook portion in a first direction;

a slide bar closing and opening the hook portion by reciprocating in the first direction;

a connection ring rotatably connected to an end of the stem portion with respect to the first direction, having a predetermined contour, and extending in a second direction perpendicular to the first direction;

at least one projection extending from an outer circumferential portion of the connection ring in the second direction by a predetermined length; and

an operation member connected to the slide bar and extending toward the connection ring,

whereby the operation member abuts only the projection when being moved in the first direction.

### Advantageous Effects of Invention

A coupler for animal according to the present invention can prevent a movement of object to be coupled from transmitting to a slide bar as a push-back force.

### BRIEF DESCRIPTION OF DRAWINGS

FIG. 1 is a drawing showing a construction of a coupler for animal according to a first embodiment of the present invention, wherein (a) shows an elevational view showing the coupler in a state where a hook portion is opened, (b) shows a side view of the coupler looked in a direction indicated by an arrow IB in (a), and (c) shows an elevational view showing the coupler in a state where the hook portion is closed.

FIG. 2 is a cross sectional view showing relative positions of a stem portion of a snap hook member and an end portion of an operation member in relation to a seat portion of a connection ring in the coupler shown in FIG. 1.

FIG. 3 is a drawing showing a construction of an alternative of the coupler for animal according to the first embodiment, wherein (a) shows an elevational view showing the coupler in a state where the hook portion is opened, (b) shows a side view of the coupler looked in a direction indicated by an arrow IIIB in (a), and (c) shows an elevational view showing the coupler in a state where the hook portion is closed.

FIG. 4 is an elevational view showing a construction of an alternative of the connection ring according to the first embodiment.

FIG. 5 is a drawing showing a construction of an alternative of the operation member according to the first embodiment.

FIG. 6 is a drawing showing a construction of a coupler for animal according to a second embodiment of the present invention, wherein (a) shows an elevational view showing the coupler in a state where a hook portion is opened, (b) shows a side view of the coupler looked in a direction indicated by an arrow VIB in (a), and (c) shows an elevational view showing the coupler in a state where the hook portion is closed.

FIG. 7 is a cross sectional view showing relative positions of a stem portion of a snap hook member and an end portion of an operation member in relation to a seat portion of a connection ring in the coupler shown in FIG. 6.

FIG. 8 is a drawing showing a construction of an alternative of the coupler for animal according to the second embodiment, wherein (a) shows an elevational view showing the coupler in a state where the hook portion is opened, (b) shows a side view of the coupler looked in a direction indicated by an arrow VIIIB in (a), and (c) shows an elevational view showing the coupler in a state where the hook portion is closed.

FIG. 9 is an elevational view showing a construction of an alternative of the connection ring according to the second embodiment.

FIG. 10 is a drawing showing a construction of a snap hook member of a coupler for animal according to a third embodiment of the present invention.

FIG. 11 is a drawing showing a state in which a leash is joined to a collar via a conventional coupler for animal.

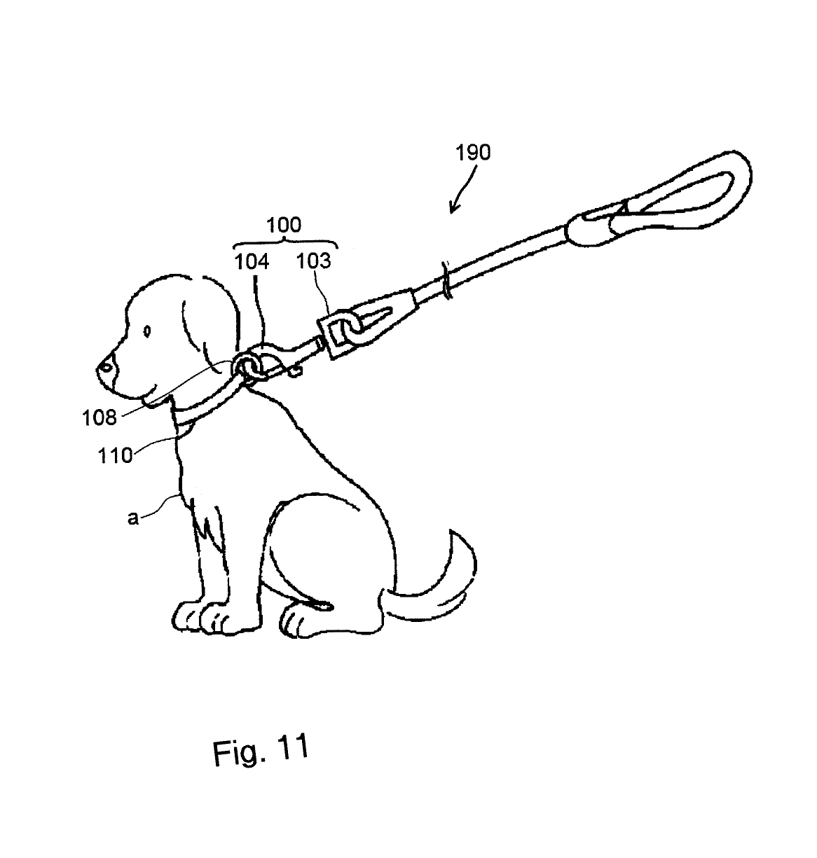

FIG. 12 is a perspective view showing the coupler for animal shown in FIG. 11.

FIG. 13 is a perspective view showing another conventional coupler for animal.

FIG. 14 is a drawing showing a further conventional coupler for animal.

### DESCRIPTION OF EMBODIMENTS

### First Embodiment

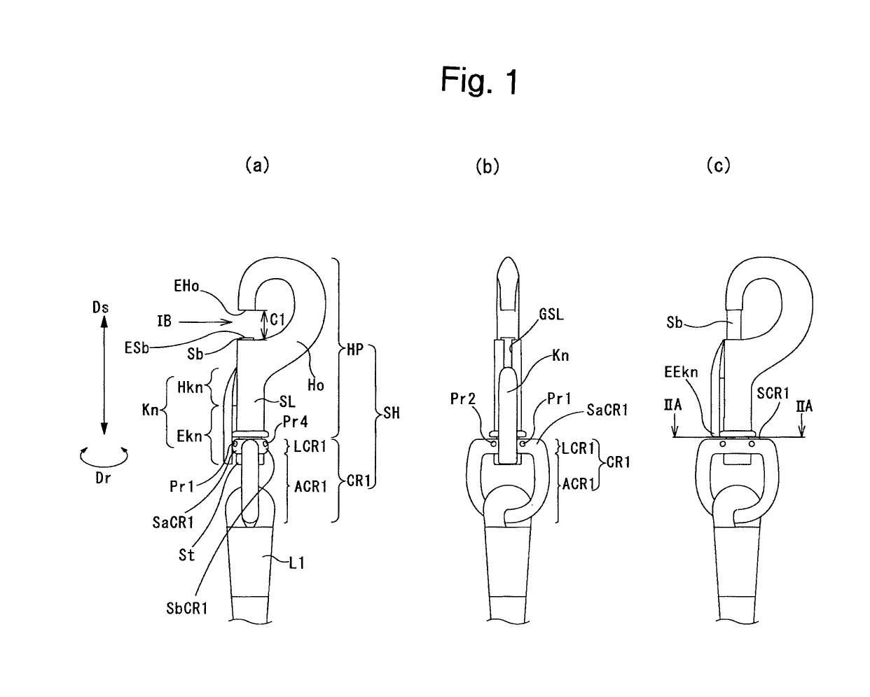

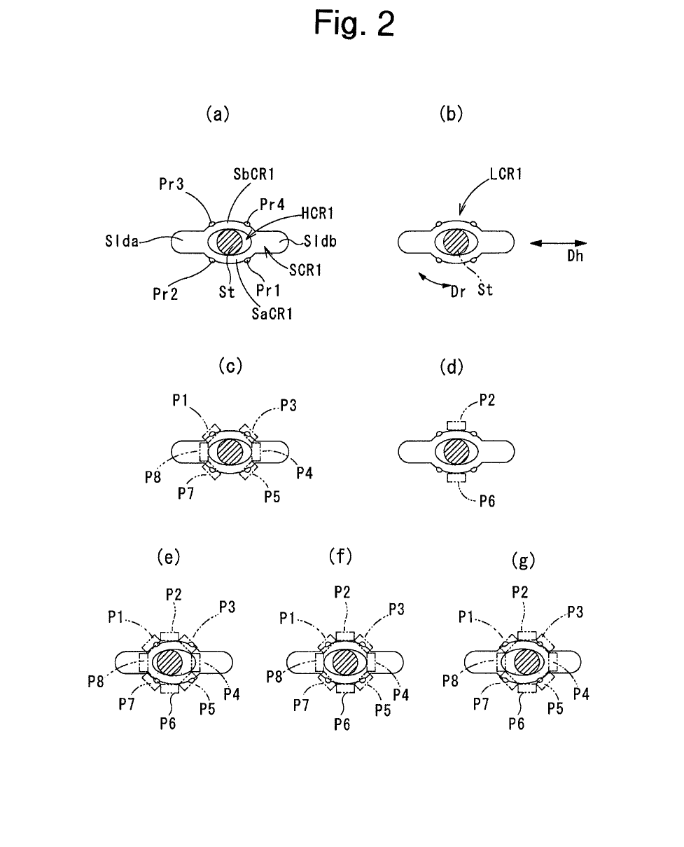

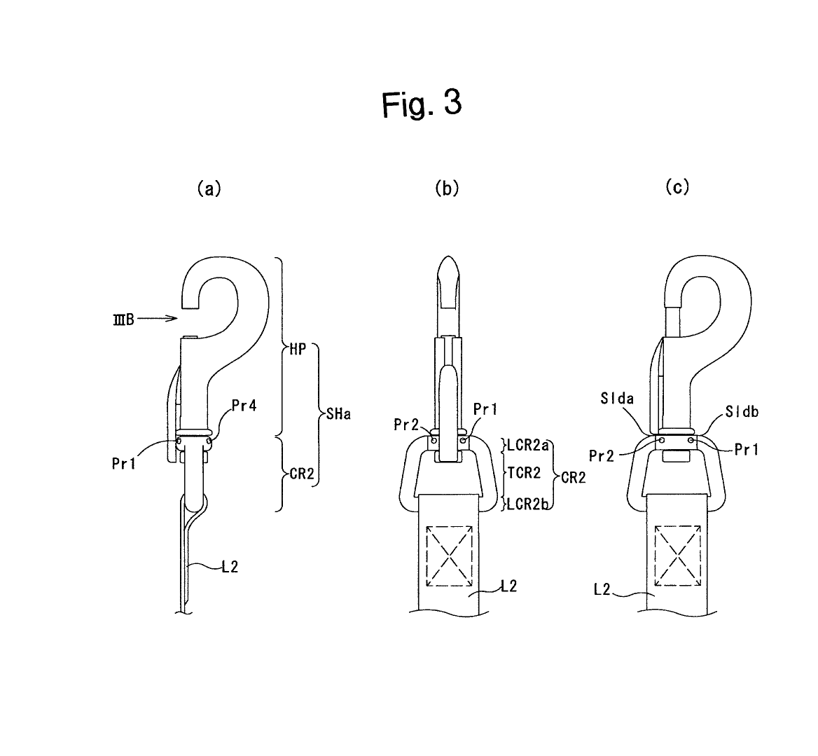

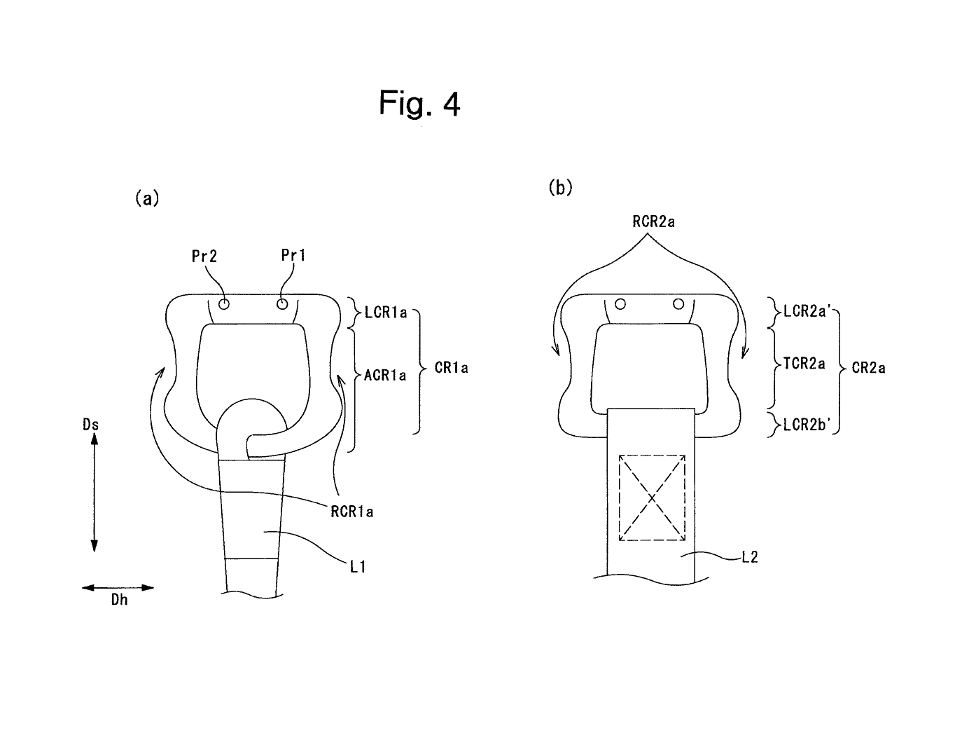

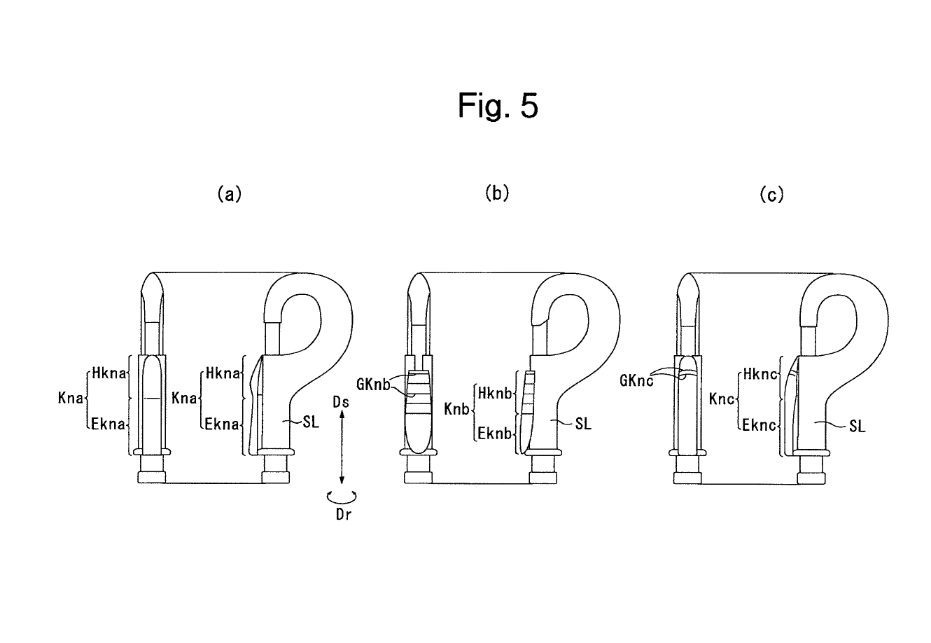

With reference to FIG. 1, FIG. 2, FIG. 3, FIG. 4, and FIG. 5, described is a coupler for animal according to a first embodiment of the present invention.

As shown in FIG. 1, a coupler for animal SH according to this embodiment (hereinafter referred to as a “coupler”) includes a snap hook member HP having an openable hook portion and a connection ring CR1 rotatably connected to the snap hook member HP. Shown in FIG. 1(a) and FIG. 1(b) is the coupler SH in a state where the hook portion is opened, and shown in FIG. 1(c) is the coupler SH in a state where the hook portion is closed.

The snap hook member HP and the connection ring CR1 are both made of metal. First described is the structure of the snap hook member HP, and then the structure of the connection ring CR1 is described.

The snap hook member HP includes a hook portion Ho formed in a “C” shape, a stem portion SL formed in a tubular shape and integrally with the hook portion Ho, and a slide bar Sb being housed inside the stem portion SL. A distal end face EHo (hereinafter referred to as a “hook portion's distal end face EHo”) opposes to a distal end face of the stem portion SL with a predetermined interval C1. A gap formed between the hook portion's distal end face EHo and the distal end face of the stem portion SL is referred to as an opening of the snap hook member HP.

In the stem portion SL, a groove GSL (FIG. 1(b)) is formed along the stem direction Ds. The slide bar Sb is biased by a spring (not shown) housed inside the stem portion SL so that a distal end face ESb (hereinafter referred to as a “slide bar's distal end face ESb”) abuts against the hook portion's distal end face EHo. An operation member Kn in a rod-shape is integrally formed with the slide bar Sb, and the operation member Kn exposes outside of the stem portion SL through the groove GSL.

By moving the operation member Kn along the stem direction Ds toward the side of connection ring CR1 against the biasing force of the spring described in the above, the slide bar's distal end face ESb is separated from the hook portion's distal end face EHo to form a gap therebetween. Hereinafter, the movement of the operation member Kn toward the connection ring CR1 is referred to as a “hook portion opening operation by the operation member Kn.”

In the coupler SH, a stopper mechanism preventing the slide bar Sb from moving (backward) against the user's intention is constructed between the operation member Kn and the connection ring CR1. Specifically, at least one projection which abuts the operation member Kn when the operation member Kn moves toward the connection ring CR1 against the user's intention is provided in an outer circumferential portion of the connection ring CR1. Below, the constructions of the operation member Kn and the connection ring CR1 will be described detailedly, and the stopper mechanism is also described.

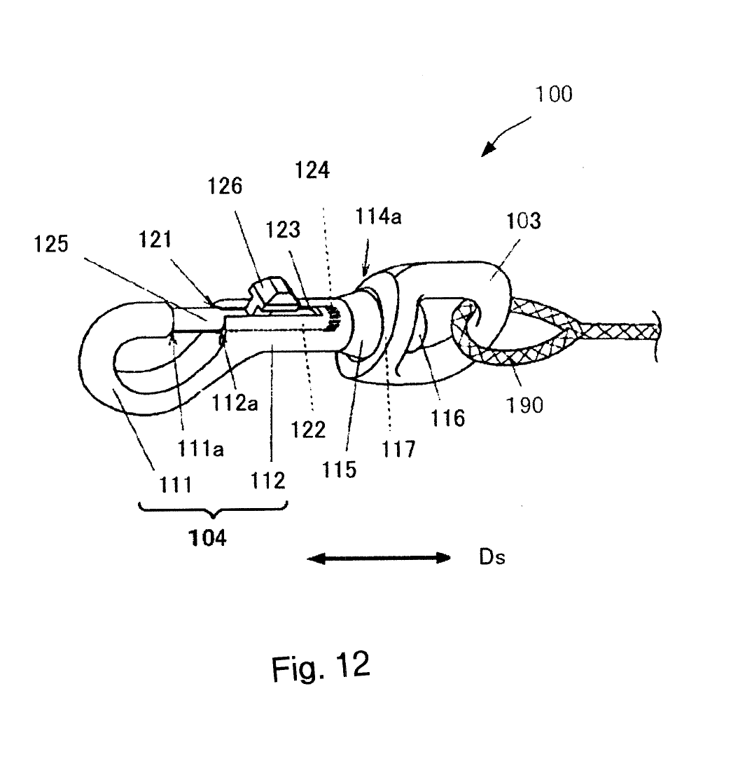

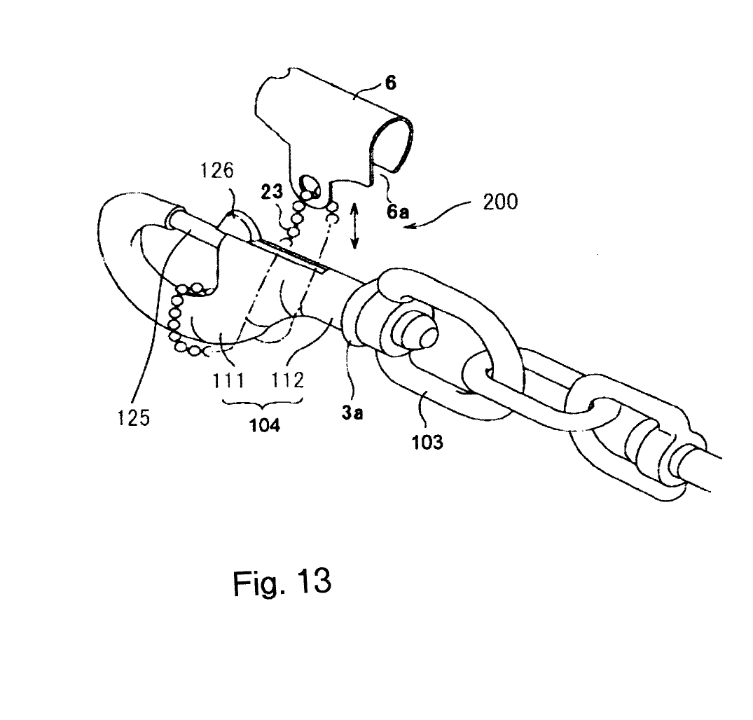

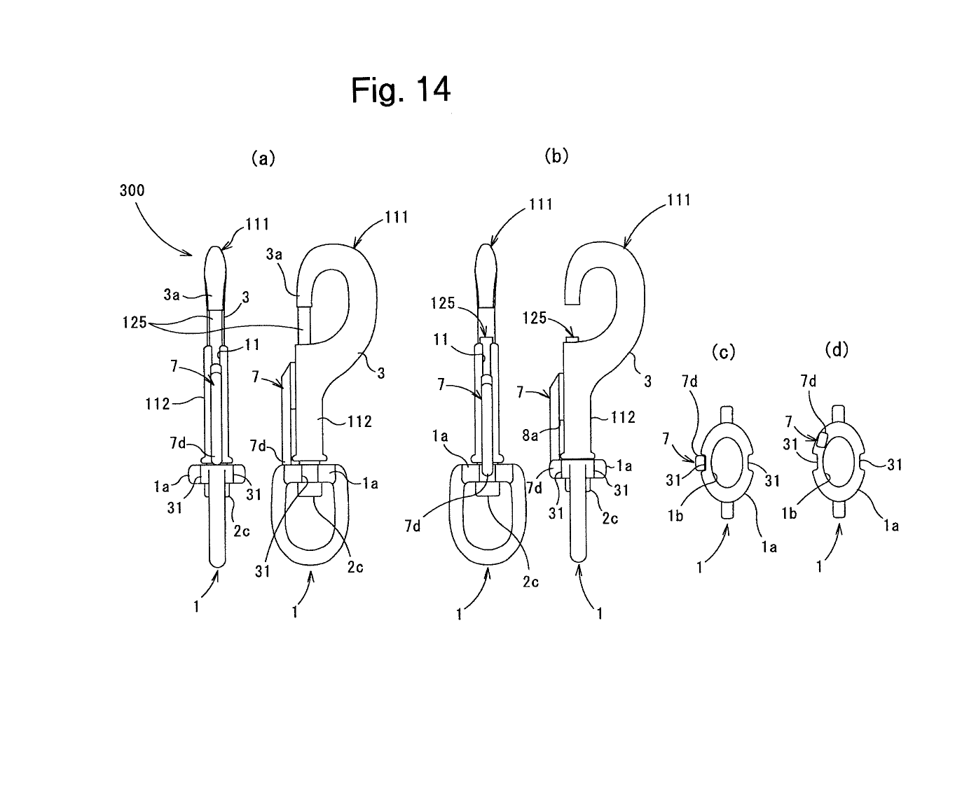

The operation member Kn is longer than the conventional operation member 126 (FIG. 12, FIG. 13) as the operation member 7 (Patent Literature 3) described with reference to FIG. 14 is. As shown in FIG. 1(a), the operation member Kn includes a hold portion HKn and an extension portion EKn integrally formed with the hold portion HKn. The external contour of the hold portion HKn slopes more gently in the direction perpendicular to the stem direction Ds, compared with that of the hold portion (FIG. 14) of the operation member 7.

Next, the construction of the connection ring CR1 is described. Like the conventional connection ring 103 described with reference to FIG. 12, the connection ring CR1 has a “D” shape contour, and includes a linear portion LCR1 and an arc-shaped portion ACR1 integrally formed with the linear portion LCR1. In the linear portion LCR1, a through hole HCR1 (FIG. 2(a)) is formed. The connection ring CR1 is rotatably installed in the snap hook member HP such that a stem St of the snap hook member HP is inserted in the through hole HCR1. A direction in which the connection ring CR1 can rotate is referred to as a rotation direction Dr. A leash L1 having a round-shaped section is fastened to the connection ring CR1.

The linear portion LCR1 of the connection ring CR1 includes two faces SaCR1 and SbCR1 both extending along the stem direction Ds and opposing to each other. The above described through hole HCR1 is formed at a face SCR1 opposed to the end of the stem portion SL of the linear portion LCR1. The face SCR1 is about perpendicular to the faces SaCR1 and SbCR1. The face SCR1 has a predetermined contour and extends in a direction perpendicular to the stem direction Ds.

As shown in FIG. 1(c), in the coupler SH in a state where the hook portion Ho is closed, an end portion EEKn of the operation member Kn abuts or comes close to the face SCR1 of the connection ring CR1. As described later, the face SCR1 receives the end portion EEKn of the operation member Kn so as to limit the movement of the slide bar Sb in the stem direction Ds. In this sense, the face SCR1 is hereinafter referred to as a “seat portion SCR1”. The shape and function of the seat portion SCR will be described later with reference to FIG. 2(a) to FIG. 2(g).

In the linear portion LCR1, formed are projection portions Pr1, Pr2, Pr3, and Pr4 (generally referred to as a projection portion Pr, as necessary) which are hemispherical projections each extending in a direction perpendicular to the stem direction Ds. Specifically, among the four projection portions, two projection portions Pr1 and Pr2 are formed in the face SaCR1, and two projection portions Pr3 and Pr4 are formed in the face SbCR1 of the linear portion LCR1. The projection portion Pr can be formed by, for example, a press working.

Opening the hook portion Ho of the coupler SH is achieved such that the operation member Kn is moved toward the connection ring CR1 in the stem direction Ds to separate the slide bar's distal end face ESb from the hook portion's distal end face EHo. The movement of the operation member Kn toward the connection ring CR1, or hook portion opening operation, can be possible only when the operation member Kn is located on a predetermined relative position in relation to the seat portion SCR1 of the connection ring CR1. A relative position in relation to the seat portion SCR1 of the operation member Kn where the hook portion opening operation is allowed is hereinafter referred to as an “unlock position”. In contrast to this, a relative position in relation to the seat portion SCR1 of the operation member Kn where the hook portion opening operation is prevented is hereinafter referred to as a “lock position”.

Before opening the hook portion Ho, the snap hook member HP is rotated in the rotation direction Dr so that the operation member Kn is located on the unlock position. The unlock position is the position where the end portion EEKn of the operation member Kn is not received by the seat portion SCR1, and specifically is the position where the end portion EEKn opposes to a gap between the two projection portions formed in the face SaCR1 or SbCR1 of the linear portion LCR1. By moving the operation member Kn located on the unlock position toward the connection ring CR1, the slide bar Sb is moved in the stem direction Ds and the hook portion Ho is opened. According to an example of the coupler SH with the hook portion Ho is opened shown in FIG. 1(a) and FIG. 1(b), the extension portion EKn of the operation member Kn is located between the projection portions Pr1 and Pr2.

Next described with reference to FIG. 2 (a) to FIG. 2 (g) is the linear portion LCR1 particular to shape and function of the seat portion SCR1. FIG. 2 (a) is a cross sectional view of the coupler taken along a line IIA-IIA in FIG. 1 (c). As described in the above, the seat portion SCR1 limits the movement in the stem direction Ds of the slide bar Sb by receiving the end porton EEKn of the operation member Kn as well as allows the slide bar Sb to move in the stem direction Ds at the predetermined position (the unlock position). That is, the seat portion SCR1 serves both as a lock means for preventing the slide bar Sb from moving in the stem direction Ds and an unlock means for allowing the slide bar Sb to move in the stem direction Ds.

As shown in FIG. 2 (a) and FIG. 2 (b), the linear portion LCR1 (the seat portion SCR1) is basically composed by adding the projection portions Pr1, Pr2, Pr3, and Pr4 to the linear portion of the conventional connection ring 103 (FIG. 12, FIG. 13). The projection portions Pr and shoulder portions Slda and Sldb (generally referred to as a shoulder portion Sld, if necessary) receive the end portion EEKn of the operation member Kn to prevent the slide bar Sb from moving in the stem direction Ds. The Gaps between the projection portions Pr1 and Pr2 formed in the face SaCR1 and between the projection portions Pr3 and Pr4 formed in the face SbCR1 allow the movement of the end portion EEKn of the operation member Kn to allow the slide bar Sb to move in the stem direction Ds.

In the seat portion SCR1, a portion to define the through hole HCR1 is thin, compared with the discoid oval ring 1a of the conventional ring 1 (Patent Literature 3) described with reference to FIG. 14, and is thick as almost same as one side (linear portion) of the connection ring 103 with the through hole 114a formed therein (FIG. 12).

In the manufacturing process of the coupler SH, the linear portion LCR1 of the connection ring CR1 is formed by pressing a circular ring with the stem St being inserted therein to plastically deform into generally an oval shape. The four projection portions Pr, provided on an outer circumferential thereof beforehand, do not cause stress concentration or maldistribution during the plastic deformation of the ring. Since the circular ring is thick almost same as that of a ring used for manufacturing the conventional connection ring 103, the connection ring CR1 with a stopper mechanism integrally composed with the main body can be obtained without reducing the yield or the productivity.

Among plural positions which the end portion EEKn of the operation member Kn can be located in relation to the seat portion SCR1, the end portion EEKn abuts either of any one of the projection portions Pr and the shoulder portions Sld in positions other than the unlock positions where the slide bar Sb is allowed to move in the stem direction Ds. That is, among the positions in which the end portion EEKn can be located in relation to the seat portion SCR1, positions other than the unlock positions are the lock positions where the slide bar Sb is prevented from moving in the stem direction Ds.

As shown in FIG. 2(c) and FIG. 2(d), the end portion EEKn can be located in eight positions P1, P2, P3, P4, P5, P6, P7, and P8 in relation to the seat portion SCR1. Among the eight positions P1 to P8, the six positions P1, P3, P4, P5, P7, and P8 shown in FIG. 2(c) are the lock positions, and the two positions P2 and P6 shown in FIG. 2(d) are the unlock positions.

The stem St of the snap hook member HP is rotatable in the rotation direction Dr inside the through hole HCR1, as well as movable in a direction Dh perpendicular to the stem direction Ds within a predetermined range. The size in the direction Dh of the gap between the two projection portions Pr is greater than the length (width) in the direction Dh of the operation member Kn. Therefore, even if the stem St shifts in the direction Dh within the through hole HCR1, it is possible to move the end portion EEKn of the operation member Kn to open the hook portion Ho.

With reference to FIG. 2(e), FIG. 2(f), and FIG. 2(g), described is the lock position and the unlock position when the stem St shifts in the direction Dh within the through hole HCR1. Shown in FIG. 2(f) is the stem St located at a center of the through hole HCR1 in the direction Dh. Shown in FIG. 2(e) is the stem St shifted to the left side in the figure within the through hole HCR1. Shown in FIG. 2(g) is the stem St shifted to the right side in the figure within the through hole HCR1.

Every case shown in FIG. 2(e), FIG. 2(f), and FIG. 2(g), the end portion EEKn is allowed to move in the stem direction Ds when the end portion EEKn is located in the two positions P2 and P6 among the eight possible positions P1 to P8. In the other positions P1, P3, P4, P5, P7, and P8, the end portion EEKn abuts either of any one of the projection portions Pr and the shoulder portions Sld, and the end portion EEKn is hampered to move in the stem direction Ds.

Next, described with reference to FIG. 3 is a first alternative embodiment of the coupler SH. While the leash L1 having a round-shaped section is fastened to the coupler SH, a belt-shaped leash L2 is fastened to a coupler SHa. The coupler SHa has a construction similar to that of the coupler SH except that the connection ring CR1 is replaced with a connection ring CR2. Hereinafter, mainly described is the connection ring CR2.

While the above described connection ring CR1 (FIG. 1 (b)) has the “D” shape contour, the connection ring CR2 has a trapezoidal contour. The connection ring CR2 includes a linear portion LCR2a, a linear portion LCR2b, and a pair of side portions TCR2 connecting the linear portion LCR2a and the linear portion LCR2b. The liner portion LCR2a and the linear portion LCR2b are parallel to each other. To the linear portion LCR2b, the belt-shaped leash L2 is fastened.

Basically, the linear portion LCR2a has a construction similar to that of the above described linear portion LCR1 (the connection ring CR1), and includes the shoulder portions Slda and Sldb as well as the projection portions Pr1 to Pr4. The linear portion LCR2a functions as the above described linear portion LCR1 does and works as the lock means to prevent the slide bar Sb from moving in the stem direction Ds and the unlock means to allow the slide bar Sb to move in the stem direction Ds.

Next, with reference to FIG. 4, alternative embodiments of the connection ring CR1 and the connection ring CR2 are described, respectively. A connection ring CR1a shown in FIG. 4(a) has a D-like inner circumference as the connection ring CR1 (FIG. 1) does, but differs in that a pair of recessed portions RCR1a is formed therein.

The connection ring CR1a includes a linear portion LCR1a and an arc-shaped portion ACR1a integrally formed with the linear portion LCR1a. The linear portion LCR1a is longer in the direction Dh than the linear portion LCR1 (FIG. 1). Compared with the arc-shaped portion ACR1 (FIG. 1), the arc-shaped portion ACR1a has portions extruding in the direction Dh in the vicinity of the portion to which the leash L1 is fastened. The recessed portions RCR1a and RCR1a are formed in the connection ring CR1a so as to concave from the outer surface toward the inner circumference thereof. In the connection ring CR1a with the recessed portion RCR1a and RCR1a, since the recessed portions RCR1a function as a hold for the user's fingers, an improved operability is realized.

A connection ring CR2a shown in FIG. 4(b) has a trapezoidal inner circumference as the connection ring CR2 (FIG. 3) does, but differs in that a pair of recessed portions RCR2a is formed therein. The connection ring CR2a includes a linear portion LCR2a′ and a linear portion LCR2b′, and a pair of side portions TCR2a connecting the linear portion LCR2a′ and the linear portion LCR2b′. The linear portion LCR2a′ is longer in the direction Dh than the linear portion LCR2a (FIG. 3), and the linear portion LCR2b′ is longer in the direction Dh than the linear portion LCR2b (FIG. 3). The recessed portions RCR2a and RCR2a are formed in the connection ring CR2a so as to concave from the outer surface toward the inner circumference thereof. The recessed portion RCR2a functions as a hold for the user's fingers, as the recessed portion RCR1a does.

Next, with reference to FIG. 5, alternative embodiments of the operation member Kn is described. An operation member Kna shown in FIG. 5 (a) is formed in a rod-shape as the operation member Kn (FIG. 1) is, and includes a hold portion HKna and an extension portion EKna integrally formed with the hold portion HKna. An external contour of the operation member Kna in a direction perpendicular to the stem direction Ds concaves at a boundary portion between the hold portion HKna and the extension portion EKna toward the stem portion SL.

An operation member Knb shown in FIG. 5 (b) is formed in a rod-shape as the operation member Kn (FIG. 1) is, and includes a hold portion HKnb and an extension portion EKnb integrally formed with the hold portion HKnb. The operation member Knb is longer (wider) in the rotation direction Dr than the operation member Kn (FIG. 1). In the hold portion HKnb, a plurality of grooves GKnb are formed along a direction perpendicular to the stem direction Ds.

An operation member Knc shown in FIG. 5 (c) is formed in a rod-shape as the operation member Kn (FIG. 1) is, and includes a hold portion HKnc and an extension portion EKnc integrally formed with the hold portion HKnc. In the hold portion HKnc, a plurality of grooves GKnc are formed along a direction perpendicular to the stem direction Ds.

### Second Embodiment

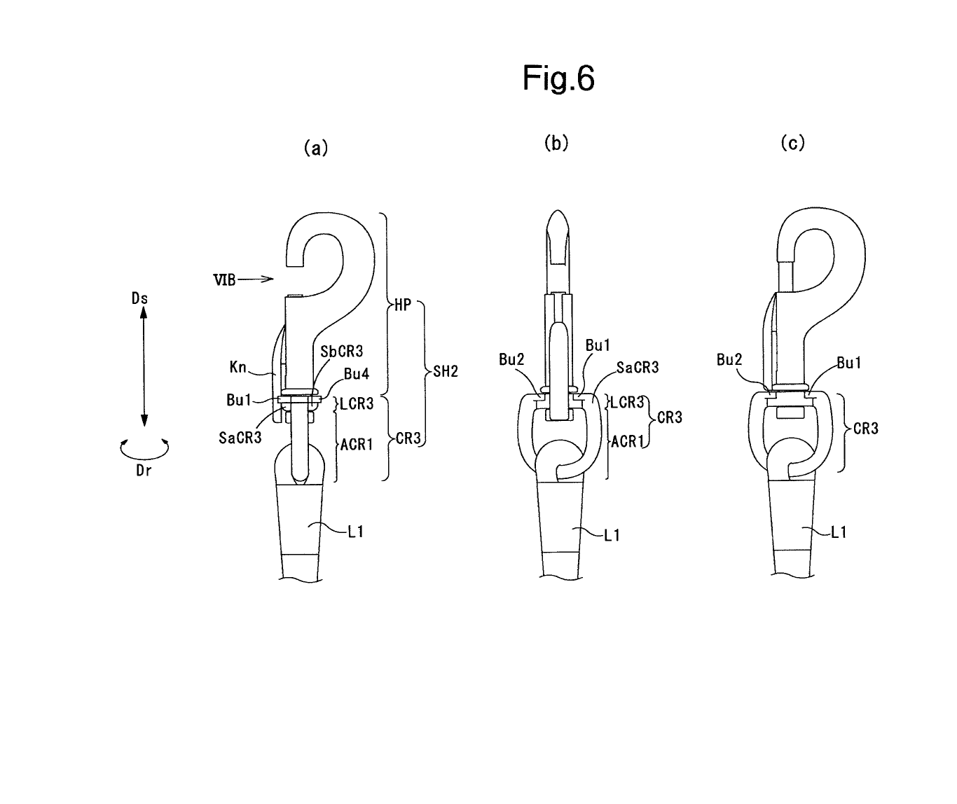

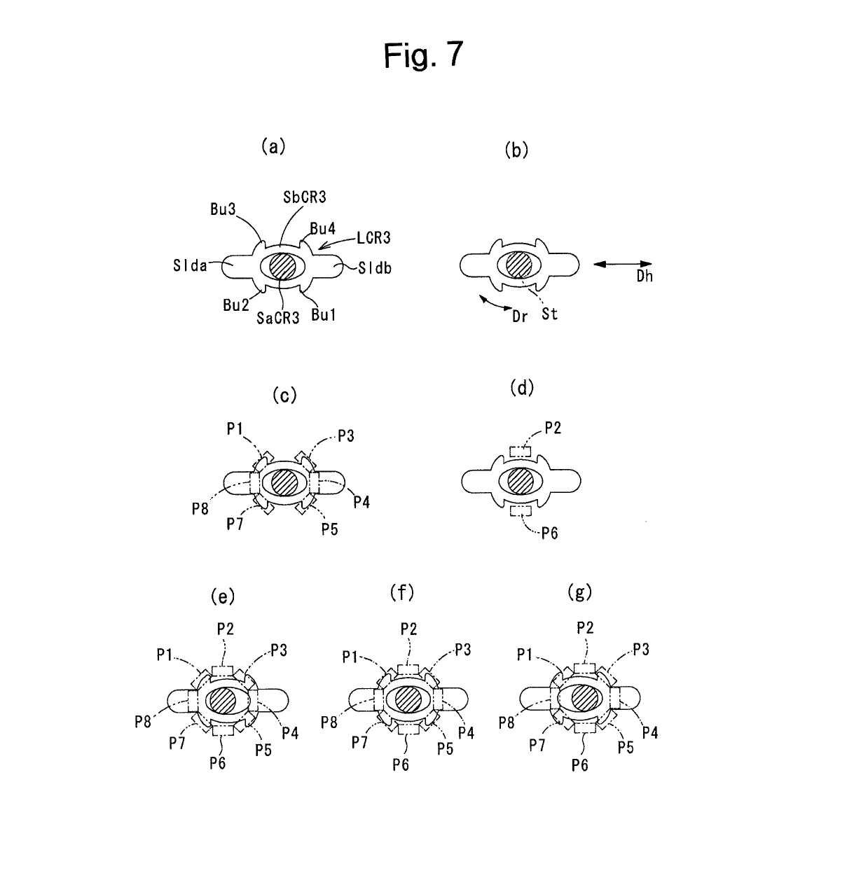

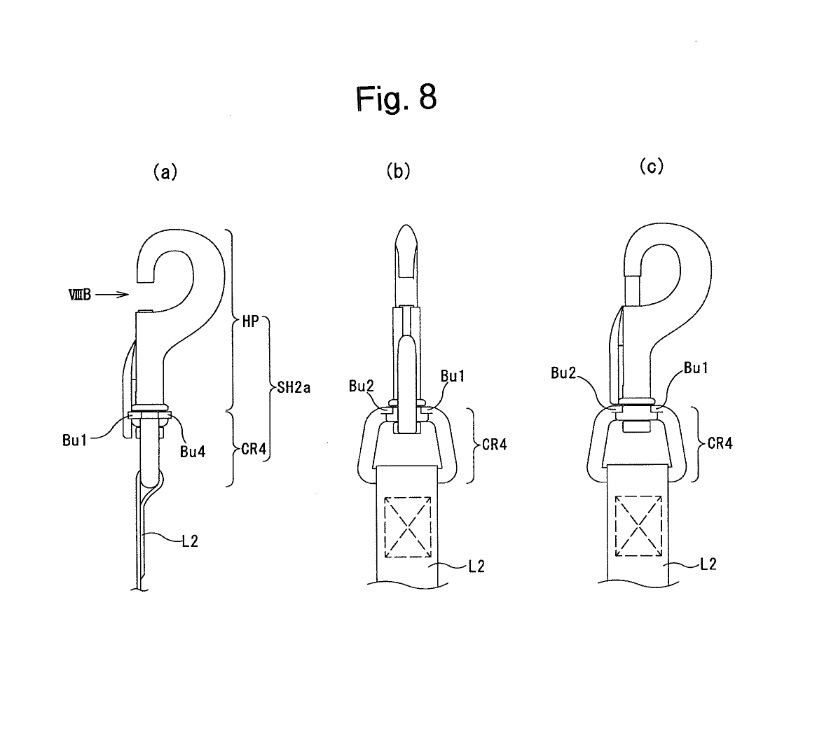

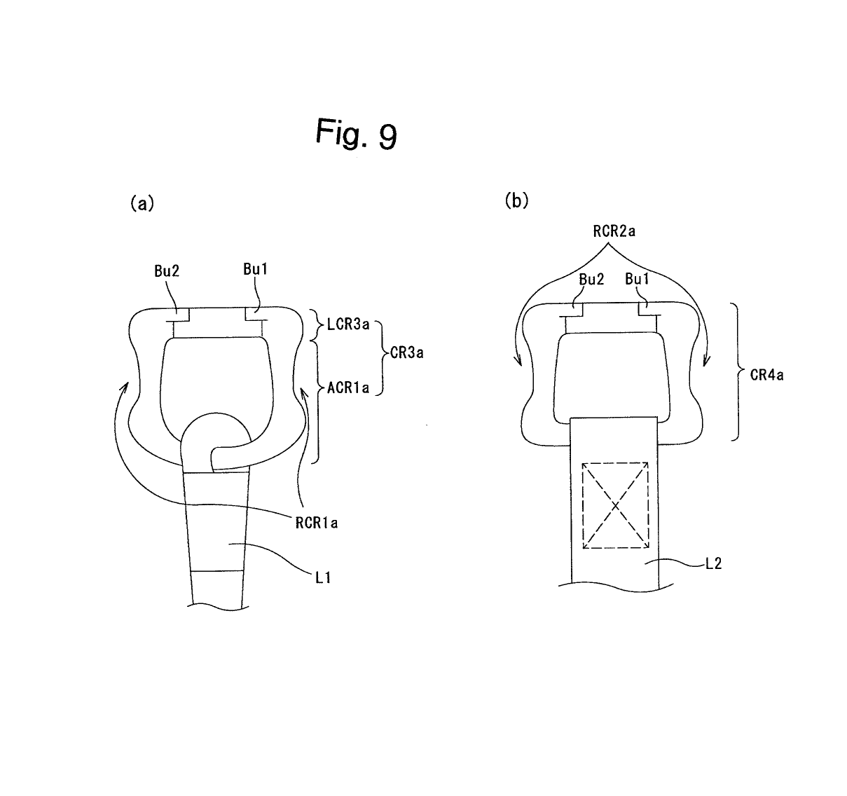

Below described with reference to FIG. 6, FIG. 7, FIG. 8, and FIG. 9 is a coupler for animal according to a second embodiment of the present invention. A coupler SH2 shown in FIG. 6 has a construction similar to that of the above described coupler SH except that the connection ring CR1 is replaced with a connection ring CR3. In simple, the connection ring CR3 is the connection ring CR1 but the four projection portions Pr are replaced with four pieces of bump portions Bu formed like a talon.

As shown in FIG. 7(a) and FIG. 7(b), a linear portion LCR3 of the connection ring CR3 is the linear portion LCR1 of the connection ring CR1 according to the above described first embodiment but those projection portions Pr1, Pr2, Pr3, and Pr4 are replaced with bump portions But, Bu2, Bu3, and Bu4 (generally referred to as the bump portions Bu, as necessary). A volume of the bump portion Bu is greater than that of the projection portion Pr. A projecting length of the bump portion Bu measured from a face SaCR3 or a face SbCR3 is greater than that of the projection portion Pr measured from the face SaCR1 or the face SbCR1.

In the linear portion LCR3, the four bump portions Bu as well as the shoulder portions Slda and Sldb receive the end portion EEKn of the operation member Kn to prevent the slide bar Sb from moving in the stem direction Ds. The Gaps between the bump portions But and Bu2 formed in the face SaCR3 and between the bump portions Bu3 and Bu4 formed in the face SbCR3 allow the end portion EEKn of the operation member Kn to allow the slide bar Sb to move in the stem direction Ds.

Shown in FIG. 7(c) and FIG. 7(d) are eight possible positions P1, P2, P3, P4, P5, P6, P7, and P8 where the end portion EEKn can be located in relation to the linear portion LCR3. Among the eight possible positions P1 to P8, the six positions P1, P3, P4, P5, P7, and P8 shown in FIG. 7(c) are the lock positions, and the two positions P2 and P6 shown in FIG. 7(d) are the unlock positions.

As shown in FIG. 7(e), FIG. 7(f), and FIG. 7(g), the four bump portions Bu are provided for allowing the movement of the end portion EEKn in the stem direction Ds when the end portion EEKn is located in the two unlock positions P2 and P6, even if the stem St shifts in the direction Dh within the through hole HCR1 within the predetermined range.

Next described with reference to FIG. 8 is a first alternative embodiment of the coupler SH2. While the leash L1 having a round-shaped section is fastened to the coupler SH2, the belt-shaped leash L2 is fastened to a coupler SH2a. The coupler SH2a has a construction similar to that of the coupler SH2 except that the connection ring CR3 is replaced with a connection ring CR4.

The connection ring CR4 has the four bump portions Bu as the connection ring CR3 does, but differs in that it has a trapezoidal contour. In other words, the connection ring CR4 has a construction such that the projection portions Pr1, Pr2, Pr3, and Pr4 are replaced with the bump portions But, But, Bu3, and Bu4 in the connection ring CR2 formed in a trapezoidal shape and described with reference to FIG. 3.

Next described with reference to FIG. 9, alternative embodiments of the connection ring CR3 and the connection ring CR4 are described, respectively. While a connection ring CR3a shown in FIG. 9(a) has the four bump portions Bu as the connection ring CR3 does, but differs in that a pair of the recessed portions RCR1a described with reference to FIG. 4(a) is formed therein. In other words, the connection ring CR3a has a construction similar to that of the connection ring CR1a described with reference to FIG. 4(a) except that the projection portions Pr1, Pr2, Pr3, and Pr4 are replaced with the bump portions Bu1, Bu2, Bu3, and Bu4.

While a connection ring CR4a shown in FIG. 9(b) has the four bump portions Bu as the connection ring CR4 does, but differs in that a pair of the recessed portions RCR2a described with reference to FIG. 4(b) is formed therein. In other words, the connection ring CR4a has a construction similar to that of the connection ring CR2a described with reference to FIG. 4(b) except that the projection portions Pr1, Pr2, Pr3, and Pr4 are replaced with the bump portions Bu1, Bu2, Bu3, and Bu4.

It is needless to say that the operation member Kna, the operation member Knb, and the operation member Knc described with reference to FIG. 5(a), FIG. 5(b), and FIG. 5(c) according to the above mentioned first embodiment can be applied to the coupler SH2 or SH2a according to this embodiment.

### Third Embodiment

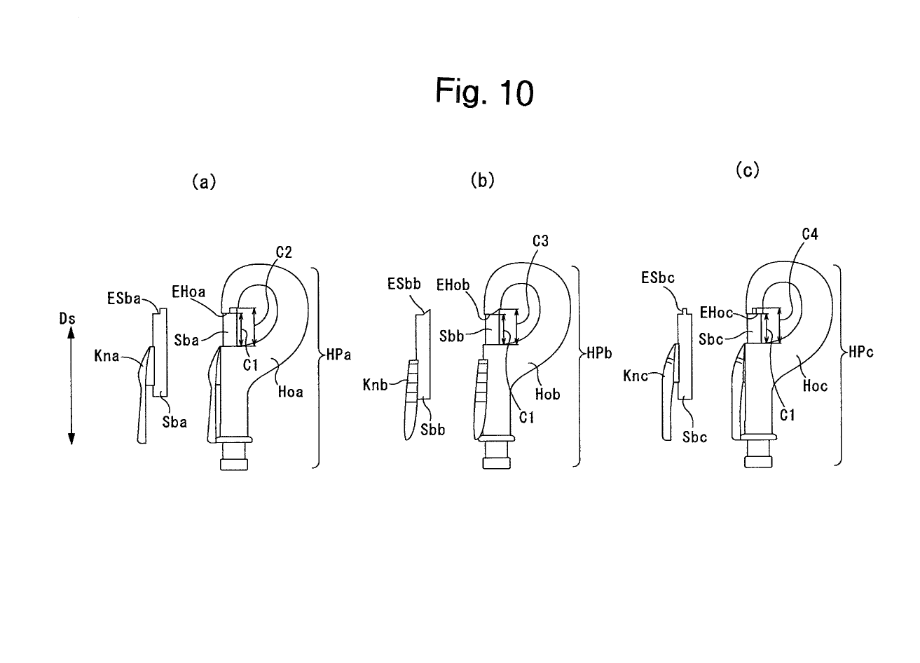

Below described with reference to FIG. 10 is a snap hook member of a coupler for animal according to a third embodiment of the present invention. In simple, a snap hook member HPa, a snap hook member HPb, and a snap hook member HPc shown in FIG. 10(a), FIG. 10(b), and FIG. 10(c), respectively have a construction similar to that of the snap hook member HP (FIG. 1) except the shapes of distal end faces of the hook portion and the slide bar. Hereinafter, the shapes of distal end faces of the hook portion and the slide bar is mainly described.

In the above described snap hook member HP (FIG. 1), the hook portion's distal end face EHo and the slide bar's distal end face ESb are about flat, and extend in a direction perpendicular to the stem direction Ds.

The snap hook member HPa shown in FIG. 10 (a) includes a hook portion Hoa and a slide bar Sba. In a hook portion's distal end face EHoa and a slide bar's distal end face ESba, steps engageable with each other are provided. A distance between the hook portion's distal end face EHoa and a distal end face of the stem portion SL is smaller on side of operation member Kna, compared with that on an inner circumferential side of the hook portion Hoa (distance C1<distance C2).

The snap hook member HPb shown in FIG. 10 (b) includes a hook portion Hob and a slide bar Sbb. In a hook portion's distal end face EHob and a slide bar's distal end face ESbb, slopes engageable with each other are provided. A distance between the hook portion's distal end face EHob and the distal end face of the stem portion SL is smaller on side of operation member Knb, compared with that on an inner circumferential side of the hook portion Hob (distance C1<distance C3).

The snap hook member HPc shown in FIG. 10 (c) includes a hook portion Hoc and a slide bar Sbc. In a hook portion's distal end face EHoc and a slide bar's distal end face ESbc, a groove and a projection engageable with each other are provided respectively. A distance between the hook portion's distal end face EHoc and the distal end face of the stem portion SL is smaller on side of operation member Knc, compared with that on side of the groove provided in the hook portion's distal end face EHoc (distance C1<distance C4).

In the snap hook member HPa described in the above, even if the slide bar Sba is moved toward the connection ring against the user's intention, the minimum distance between the hook portion's distal end face EHoa and the slide bar's distal end face ESba in the stem direction Ds becomes smaller than that in the snap hook member HP (FIG. 1) due to the above described steps.

Specifically, in order for an object to be coupled to move outside the hook portion Hoa, the object shall climb over the step provided in the slide bar's distal end face ESba first, and then the step provided in the hook portion's distal end face EHoa next, reducing the chance of releasing a coupling with the object to be connected. Due to the similar reason, also in the snap hook members HPb and HPc, the chances of releasing a coupling with the object to be connected become slim.

Although in the examples shown in the drawings, the slide bar Sba (FIG. 10(a)), the slide bar Sbb (FIG. 10(b)), and the slide bar Sbc (FIG. 10(c)) are provided with the operation member Kna, the operation member Knb, and the operation member Knc, respectively, it is needless to say that any operation member having a shape different from that of the examples shown in the drawings can be employed.

### INDUSTRIAL APPLICABILITY

The present invention is applicable to a coupler for animal.

### REFERENCE SIGNS LIST

SH, SHa, SH2, SH2a coupler
HP, HPa, HPb, HPc snap hook member
Ho, Hoa, Hob, Hoc hook portion
CR1, CR1a, CR2, CR2a, CR3, CR3a, CR4, CR4a connection ring
SL stem portion
Sb, Sba, Sbb, Sbc slide bar
Kn, Kna, Knb, Knc operation member
HKn, HKna, HKnb, HKnc hold portion
EKn, EKna, EKnb, EKnc extension portion
EEKn end portion
Pr, Pr1, Pr2, Pr3, Pr4 projection portion
Bu, Bu1, Bu2, Bu3, Bu4 bump portion
Sld, Sida, Sldb shoulder portion
SCR1 seat portion
Ds stem direction
Dr rotation direction

1. A coupler for animal comprising:
a hook portion connectable to an object to be coupled;
a stem portion extending from an end portion of the hook portion in a first direction;
a slide bar closing and opening the hook portion by reciprocating in the first direction;
a connection ring rotatably connected to an end of the stem portion with respect to the first direction, having a predetermined contour, and extending in a second direction perpendicular to the first direction;
at least one projection extending from an outer circumferential portion of the connection ring in the second direction by a predetermined length; and
an operation member connected to the slide bar and extending toward the connection ring,
whereby the operation member abuts only the projection when being moved in the first direction.

2. The couper for animal according to claim 1, wherein a plurality of the projections are provided.

3. The coupler for animal according to claim 1, wherein the projection is a hemispherical.

4. The coupler for animal according to claim 1, wherein the projection is formed like a talon.

5. The coupler for animal according to claim 3, wherein a distance between the hemispherical projections in a third direction perpendicular to the first direction is greater than a length of the operation member in the third direction.

6. The coupler for animal according to claim 4, wherein a distance between the projections formed like a talon in a third direction perpendicular to the first direction is greater than a length of the operation member in the third direction.

7. The coupler for animal according to claim 1, wherein a groove extending in a third direction perpendicular to the first direction is formed in the operation member.

8. The coupler for animal according to claim 1, wherein steps engageable with each other are formed in a distal end face of the slide bar and a distal end face of the hook portion.

9. The coupler for animal according to claim 1, wherein slopes engageable with each other are formed in a distal end face of the slide bar and a distal end face of the hook portion.

10. The coupler for animal according to claim 1, wherein a projection and a groove engageable with each other are formed in a distal end face of the slide bar and a distal end face of the hook portion, respectively.
